(19) United States
(12) Patent Application Publication
(10) Pub. No.: US 2011/0311330 A1
(43) Pub. Date: Dec. 22, 2011

(54) EXPANSION BOLT AND FRAME USING THE SAME

(75) Inventors: FU-YUAN WU, HSINCHU COUNTY (TW); WEN-HSIUNG TSOU, HSINCHU COUNTY (TW)

(73) Assignee: ADVANCED GREEN ENERGY TECH. CORP., HSINCHU COUNTY (TW)

(21) Appl. No.: 12/820,353

(22) Filed: Jun. 22, 2010

(51) Int. Cl. F16B 13/06

(52) U.S. Cl. 411/55

(57) ABSTRACT

An expansion bolt and a frame using the same, comprising: a main body piece, a sleeve, and a nut. One end of the main body piece is provided with a T-shape cone portion having double protrusion ribs, while the other end is provided with a threaded portion; said sleeve is sleeved onto said main body piece, with its one end disposed an expansion portion and is provided with double slots corresponding to said double protrusion ribs; and said nut is screwed and locked onto said threaded portion. When said nut is screwed up along said threaded portion, it will push said expansion portion of said sleeve to move toward said T-shape cone portion, thus pushing said double slots to expand, such that said expansion portion will expand and fix tightly onto said T-shape cone portion. Said frame assembled through using said expansion bolt mentioned above can be detached and reassembled without causing damages to said frame.

### BACKGROUND OF THE INVENTION

1. Field of the Invention

The present invention relates to a lock-and-fix structure, and in particular to an expansion bolt and a frame using the same.

2. The Prior Arts

In general, a frame is composed of plurality of long and short side frames together with several angle frames. In the prior art, the fixing of long and short side frames by angle frames is realized through utilizing at least two self tapping screws to penetrate from outside the angle frame to lock and fix it respectively to the long and the short side frames, so as to achieve the effect of fixing frames. Or, alternatively, angle frames are fixed to the long and short frames by means of adhesive. However, by utilizing the self tapping screws or adhesive for fixing the frames, damages are liable to incur to the long and short side frames and angle frames in a detachment process, and it is even likely that these frames can not be reassembled for use after detachment. Furthermore, in case that the self tapping screws are used for fixing the frame, then part of the self tapping screw will be exposed as protruding after assemblage, hereby causing an unpleasant appearance for the entire assembled frame.

Therefore, presently, the design and application of a frame structure assembly of the prior art is not quite satisfactory, and it has much room for improvement.

### SUMMARY OF THE INVENTION

In view of the problems and shortcomings of the prior art, the present invention provides an expansion bolt and a frame utilizing the same, that can be used to solve the problem of the prior art.

A major objective of the present invention is to provide an expansion bolt and a frame using the same, such that the assembled frame can be detached and reassembled without causing damages to the frame.

Another objective of the present invention is to provide an expansion bolt and a frame using the same, such that bolts in the assembled frame will not be exposed, thus providing a better and pleasant outer appearance, and having a good competitive edge in the market.

In order to achieve the above-mentioned objective, the present invention provides an expansion bolt, composed mainly of a main body piece, a sleeve sleeved on the main body piece, and a nut. One end of the main body piece is provided with a T-shape cone portion having double protrusion ribs, while the other end is provided with a threaded portion. One end of the sleeve is an expansion portion provided with the double slots corresponding to the double protrusion ribs. The nut is screwed up and locked onto the threaded portion. When the nut is screwed up along the threaded portion, it will push the sleeve to move toward the T-shape cone portion, thus pushing the double slots to expand, such that the expansion portion will expand and fix tightly onto the T-shape cone portion.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a perspective view of an expansion bolt according to the present invention;

FIG. 2 is an exploded view of an expansion bolt according to the present invention;

FIG. 3 is a perspective view of an expansion bolt locked and fixed onto a frame structure according to the present invention;

FIG. 4 is a partial enlarged exploded view of an expansion bolt locked and fixed onto a frame structure according to the present invention;

FIG. 5 is a schematic diagram of an expansion bolt locked and fixed onto a frame structure according to the present invention;

FIG. 6 is a cross section view of an expansion bolt fixed tightly onto a lock-and-fix slot of a side frame, when locking and fixing the expansion bolt onto a frame structure according to the present invention;

FIG. 7 is a cross section view of a portion along line A in FIG. 6; and

FIG. 8 is a cross section view of a portion along line B in FIG. 6.

### DETAILED DESCRIPTION OF THE PREFERRED EMBODIMENT

The purpose, construction, features, functions and advantages of the present invention can be appreciated and understood more thoroughly through the following detailed description with reference to the attached drawings. And, in the following, various embodiments are described in explaining the technical characteristics of the present invention.

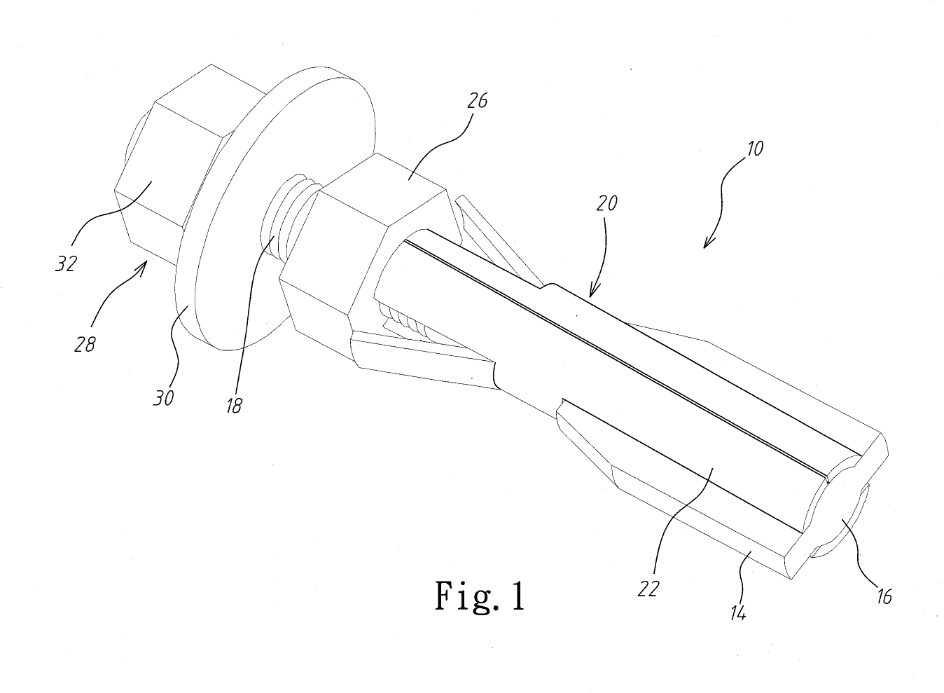

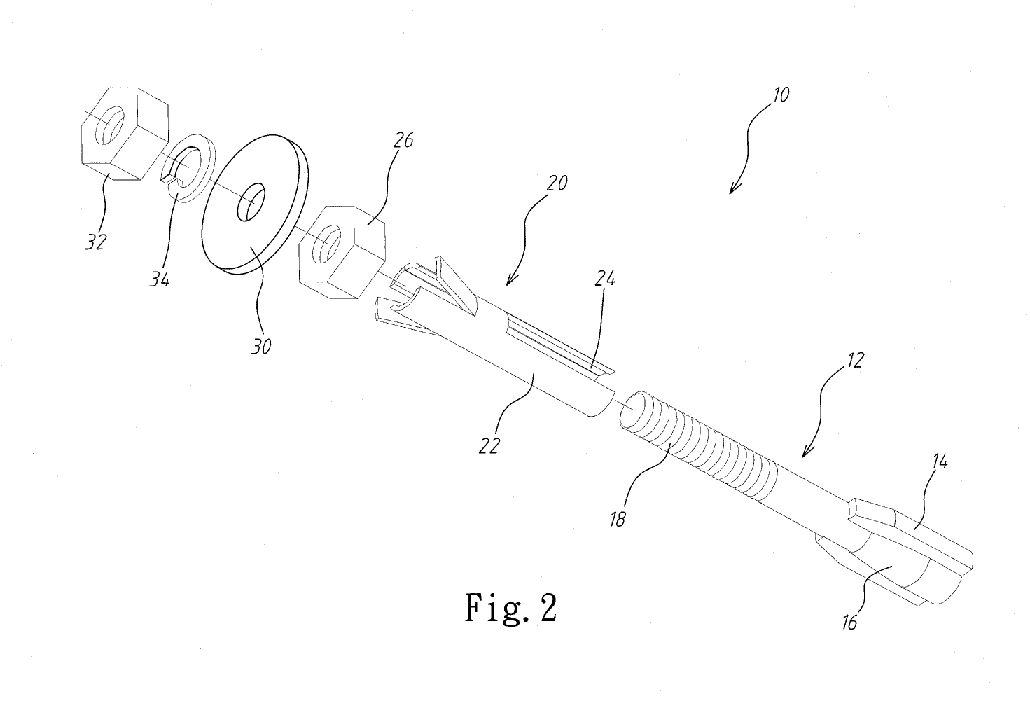

Firstly, refer to FIGS. 1 and 2 for a perspective view and an exploded view of an expansion bolt respectively according to the present invention. As shown in FIGS. 1 and 2, the present invention provides an expansion bolt 10, comprising: a main body piece 12, one end of the main body piece is provided with a T-shape cone portion 16 having double protrusion ribs 14, while the other end is provided with a threaded portion 18; a sleeve 20, which is sleeved on the main body piece 12, one end of the sleeve is disposed an expansion portion 22, that is provided with double slots 24 corresponding to the double protrusion ribs 14; and a nut 26, such as a hex cap nut, that can be screwed up and locked onto the threaded portion 18. When the nut 26 is screwed up along the threaded portion 18, it will push the sleeve 20 to move toward the T-shape cone portion 16, thus pushing the double slots 24 to expand, such that the expansion portion 22 will expand and fix tightly onto the T-shape cone portion, hereby forming a structure as shown in FIG. 1.

In addition, the expansion bolt 10 of the present invention further includes a set of position-and-lock piece 28 screwed and locked onto the threaded portion 18. The position-and-lock piece 28 is composed of a platter-shaped positioning piece 30 and a lock-and-fix piece 32, and when it is screwed up, it will push the positioning piece 30 to move toward the nut 26.

Moreover, a plastic spring washer 34 is provided for the positioning piece 30 and the lock-and-fix piece 32, so as to prevent the loosing of the positioning piece 30 and the lock-and-fix piece 32, due to vibrations.

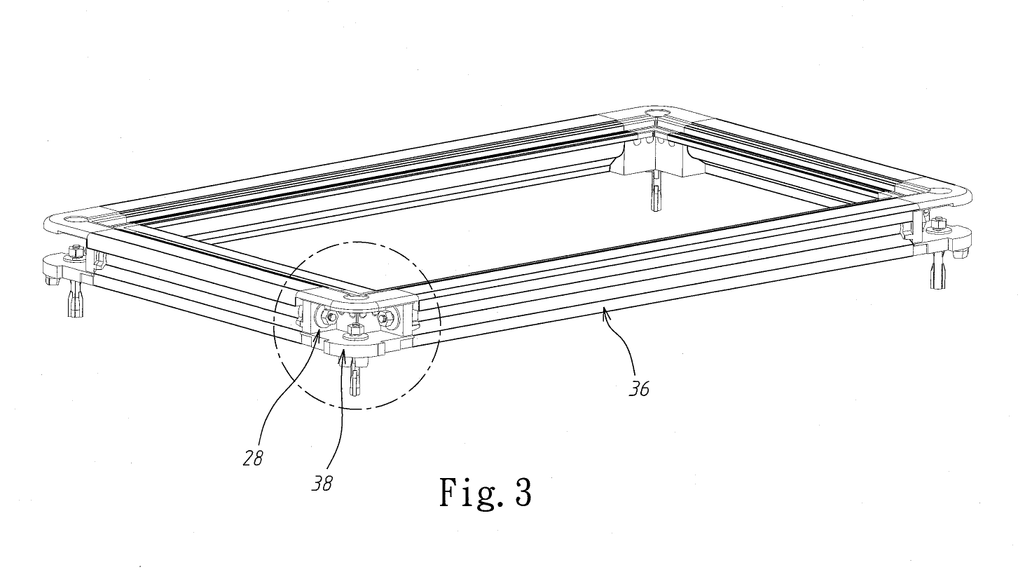

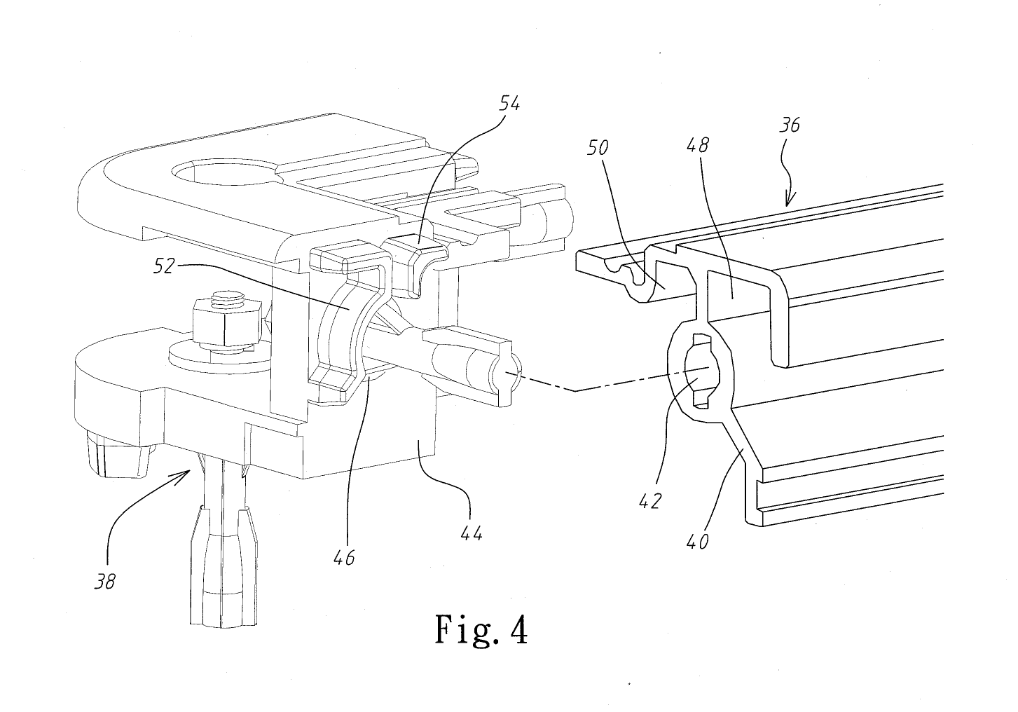

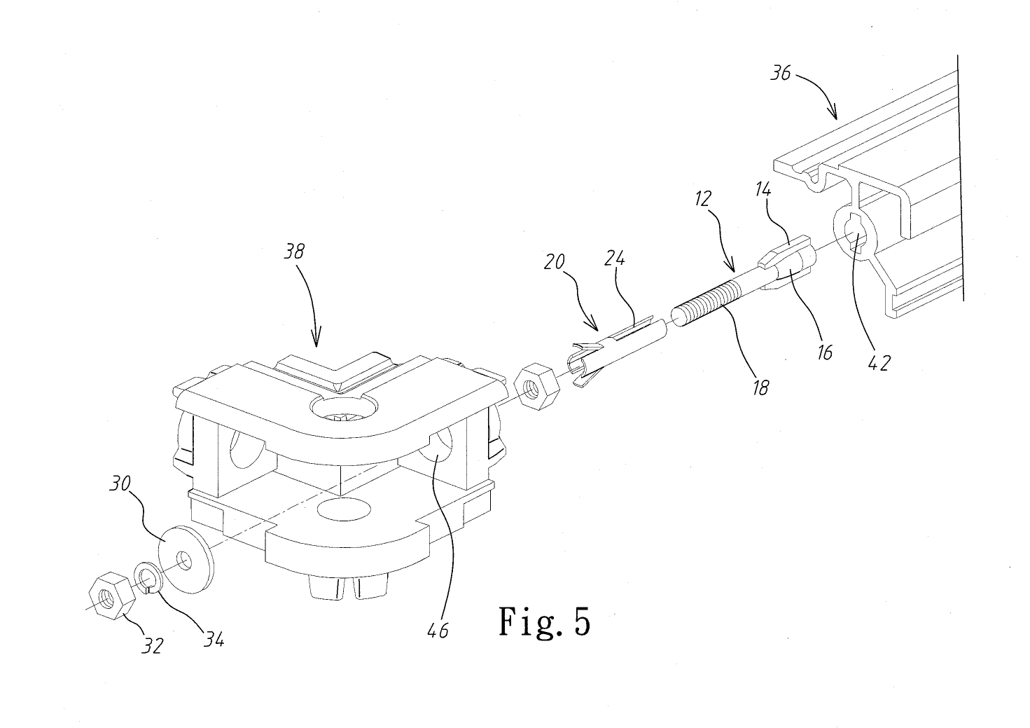

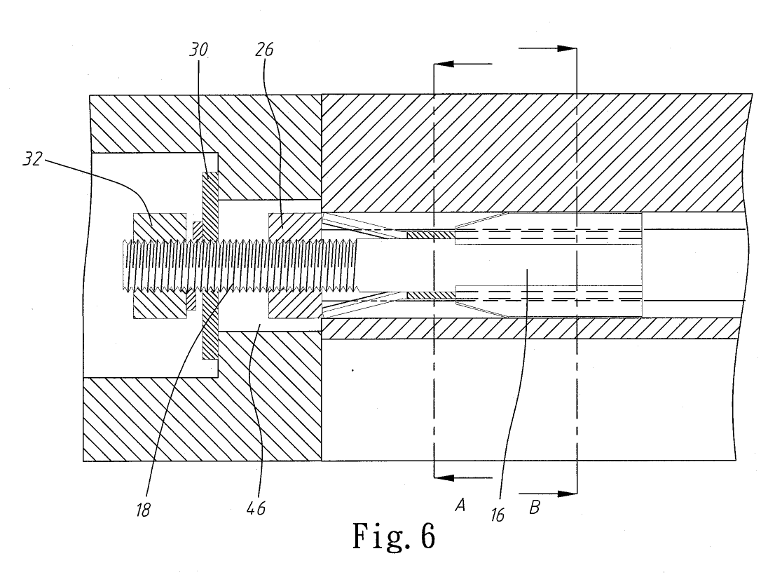

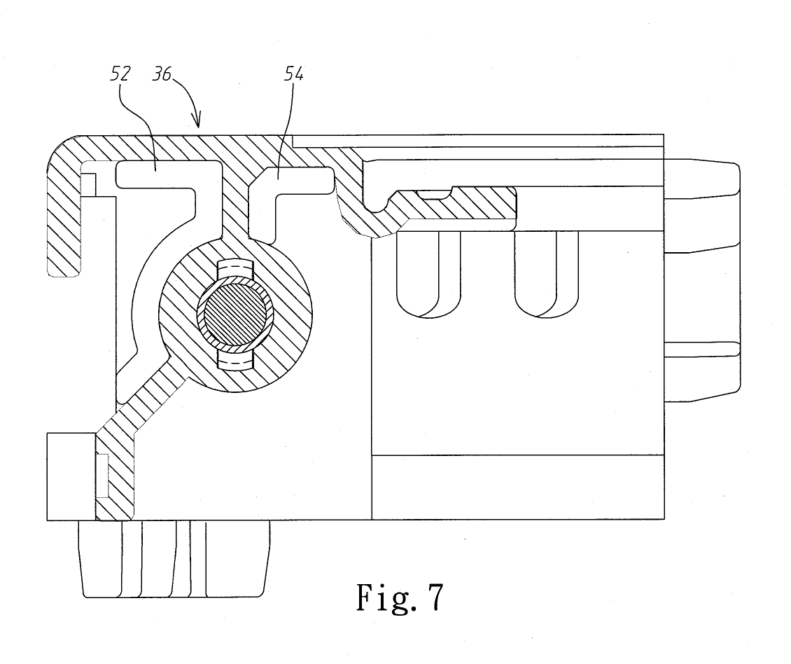

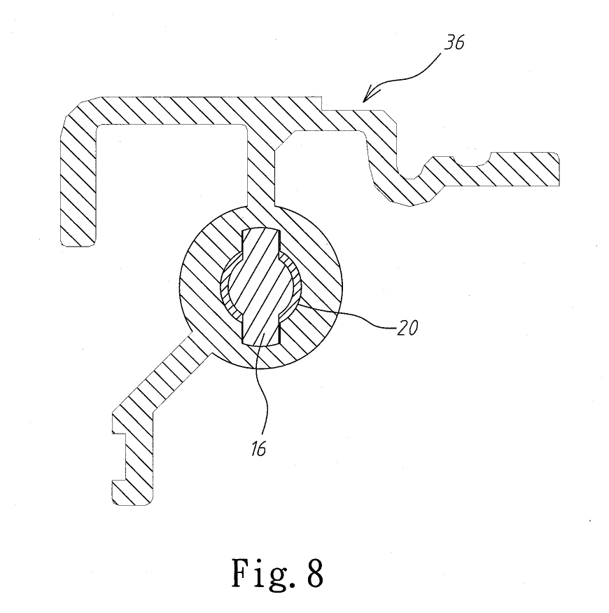

Then, refer to the following drawings for more detailed explanations of the present invention: FIG. 3 is a perspective view of an expansion bolt locked and fixed on to a frames structure according to the present invention; FIG. 4 is a partial enlarged exploded view of an expansion bolt locked and fixed onto a frame structure according to the present invention; FIG. 5 is a schematic diagram of an expansion bolt locked and fixed onto a frame structure according to the present invention; FIG. 6 is a cross section view of an expansion bolt fixed tightly onto a lock-and-fix slot of a side frame, when locking and fixing the expansion bolt onto a frame structure according to the present invention; FIG. 7 is a cross section view of a portion along line A in FIG. 6; and FIG. 8 is a cross section view of a portion along line B in FIG. 6. As shown in FIGS. 3 to 6, in applying the expansion bolt of the present invention to lock and fix the side frame 36 and angle frame 38, a lock-and-fix rib 40 is provided inside the side edge 36, and a lock-and-fix slot 42 is provided on the lock-and-fix rib 40, such that the expansion portion 22 of the sleeve 20 is pressed tightly against the inner surface of the lock-and-fix slot 42 after expansion. A side end of the angle frame 38 is provided with at least a connection plane 44 connected to the edge frame 36, and a through hole 46 is provided on the connection plane 44 for a portion of the threaded portion to penetrate through, as shown in FIG. 6.

During installation, as shown in FIG. 2 and FIG. 5, the sleeve 20 is sleeved on the main body piece 12, such that the double slots 24 correspond to the double protrusion ribs 14. Through pushing the T-shape cone portion 16, the main body piece 12 is installed in the lock-and-fix slot 42, then screwing up the nut 26 along the threaded portion 18, hereby pushing the sleeve 20 to move toward the T-shape cone portion 16, so as to make the double slots 24 to expand, thus making the expansion portion 22 to expand and fix tightly onto the T-shape cone portion 16, until the T-shape cone portion 16 is fixed tightly to the inner wall of the lock-and-fix slot 42. Subsequently, connecting the angle frame 38 to the side frame 36, thus a portion of the threaded portion 18 penetrates through the through hole 46, then screwing and locking the position-and-lock piece 28 from the inner side of the connection plane 44 onto the threaded portion 18 penetrated through the through hole 46. Since the cross section of the position-and-lock piece 28 is greater than that of the through hole 46, thus it will press against the inner side of the connection plane 44, so as to make the angle frame 38 connected to the side frame 36.

In the present embodiment, position-and-lock piece 28 includes a platter-shaped positioning piece 30 and a lock-and-fix piece 32, such that in a locking and fixing process, a platter-shaped positioning piece 30 is first sleeved onto the threaded portion 18 penetrated through the through hole 46, then the lock-and-fix piece 32 is screwed up and locked onto the threaded portion 18 penetrated through the through hole 46, so that when the lock-and-fix piece 32 is screwed up, it will push platter-shaped positioning piece 30 into pressing against the inner side of the connection plane 44.

In addition, as shown in FIG. 6, the cross section of the through hole 46 is greater than that of the nut 26, therefore nut 26 can be accommodated in the through hole 46. Moreover, a first positioning slot 48 and a second positioning slot 50 are sandwiched between the side frame 36 and lock-and-fix rib 40, and the connection plane 44 of angle frame 38 is provided with a first positioning protrusion block 52 and a second positioning protrusion block 54 correspond respectively to the first positioning slot 48 and second positioning slot 50, such that the first positioning protrusion block 52 is fastened to the first positioning slot 48, and the second positioning protrusion block 54 is fastened to the second positioning slot 50, so as to enhance the positioning and connection between the side frame 36 and the angle frame 38, as shown in FIG. 4.

A cover (not shown) can be provided around the perimeter of the angle frame 38, for covering the originally exposed position-and-lock piece 28 and threaded portion 18, so as to improve its appearance.

Summing up the above, the present invention provides an expansion bolt and a frame using the same, such that the frame assembled utilizing this kind of expansion bolt can be detached and reassembled without causing damages to the frames. Moreover, for a frame assembled using the expansion bolts of the present invention, the bolts will not be exposed, hereby its overall appearance is improved, thus having good competitive edge in the market.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. An expansion bolt, comprising:
a main body piece, with its one end provided with a T-shape cone portion having double protrusion ribs, and with its other end provided with a threaded portion;
a sleeve, sleeved onto said main body piece, one end of said sleeve is disposed an expansion portion, and is provided with double slots corresponding to said double protrusion ribs; and
a nut, screwed and locked on said threaded portion, and when said nut is screwed up along said threaded portion, it will push said sleeve to move toward said T-shape cone portion, thus making said double slots to expand, such that said expansion portion will expand and fix tightly onto said T-shape cone portion.

2. The expansion bolt as claimed in claim 1, wherein
said nut is a hex cap nut.

3. The expansion bolt as claimed in claim 1, further comprising:
a position-and-lock piece, that is screwed and locked on said threaded portion.

4. The expansion bolt as claimed in claim 3, wherein
said position-and-lock piece includes a positioning piece and a lock-and-fix piece, said positioning piece is sleeved onto said threaded portion, and said lock-and-fix piece is screwed and locked onto said threaded portion and is located on an outer side of said positioning piece, and when said lock-and-fix piece is screwed up, it will push said positioning piece to move toward said nut.

5. A frame locked and fixed through using expansion bolts as claimed in claim 1, comprising:
a side frame, provided with a lock-and-fix rib inside, and a lock-and-fix slot is provided on said lock-and-fix rib, for an expansion portion of a sleeve to press tightly inside against said lock-and-fix slot.

6. The frame as claimed in claim 5, further comprising:
an angle frame, with its side end provided with at least a connection plane connected to said side frame, a through hole is provided on said connection plane, for a portion of a threaded portion to penetrate through; and
a position-and-lock piece, screwed and locked onto said threaded portion exposed through said through hole, and a cross section of said position-and-lock piece is greater than that of said through hole, such that said position-and-lock piece will press against said connection plane in connecting said angle frame and said side frame.

7. The frame as claimed in claim 6, wherein
said position-and-lock piece includes:
a positioning piece, with its cross section greater than that of said through hole, and is sleeved onto said threaded portion exposed through said through hole; and
a lock-and-fix piece, screwed and locked onto said threaded portion exposed through said through hole, and is located on an outer side of said positioning piece, such that when said lock-and-fix piece is screwed up, it will push said positioning piece to press against said connection plane.

8. The frame as claimed in claim 5, wherein
a first positioning slot and a second positioning slot are sandwiched between side frame and said lock-and-fix rib, and said connection plane of said angle frame is provided with a first positioning protrusion block and a second positioning protrusion block correspond respectively to said first positioning slot and said second positioning slot.
